(19) United States
(12) Patent Application Publication
(10) Pub. No.: US 2018/0180882 A1
(43) Pub. Date: Jun. 28, 2018

(54) Augmented Reality Eyewear

(71) Applicant: Raja Singh Tuli, QC (CA)

(72) Inventor: Raja Singh Tuli, QC (CA)

(21) Appl. No.: 15/390,252

(22) Filed: Dec. 23, 2016

(51) Int. Cl. G02B 27/01; G02B 27/00; G06T 19/00; G06F 21/62

(52) U.S. Cl. CPC G02B 27/0172; G02B 27/0012; G06T 19/006; G06F 2221/2125; G02B 2027/0132; G02B 2027/014; G06F 21/6209

(57) ABSTRACT

A head mounted display device is capable of providing user a type of augmented reality (AR) experience with private access of the augmentation elements as represented by computer-generated (CG) contents. The core of the device comprises an optical combiner and a layer of photochromic materials or other means alike that changes from transparent to opaque when subjected to appropriate conditions, such that an occlusion mask pattern occupying a small portion of the said layer is created with dimension and position correspond to the CG content. The device allows user to selectively conceal the CG content from the surrounding people while keeping a sight of the real world whose elements are augmented or supplemented.

### BACKGROUND

### Field of the Invention

The present invention relates to an augmented reality head mount display, and more particularly, the present invention relates to an optical see-through augmented reality eyewear having improved user's privacy.

### Description of Related Art

Conventional optical see-through head mounted display (HMD) devices for use in augmented reality (AR) usually employ transparent optical components in the line of sight of the user, wherein the virtual elements generated by a computer, also referred to as computer-generated (CG) contents, are superimposed over a real-world view that is perceived directly by the user's eye. This type of HMD serves the purpose of enhancing the user's current perception of reality by overlaying with relevant and spatially-registered CG contents; however, there is no privacy control on the accessibility of the CG content due to the transparent nature of the optical components that leaves the CG content visible to both the user and the surrounding people.

The present invention is designed to automatically generate an occlusion mask that allows the user to selectively block off the CG content from view of the surrounding people such that the CG content is visible to the user only, which is particularly important when the CG content contains sensitive or confidential information.

U.S. Pat. No. 7,639,208 by Ha et. al. teaches an optical see-through HMD with occlusion support. While this device allows users to block or pass certain parts of a real-world scene that is viewed through the device, it focuses on enhancing the user's feeling that the virtual object is truly existing in the real world and the occlusion mask is based on a 3-D space mapping of the real and virtual objects, which is dissimilar to the invention described herein and lacks certain features and functional benefits that will become apparent to those skilled in the art by reading the detailed description accompanying with the drawings and the claims below.

### BRIEF SUMMARY OF THE INVENTION

The invention described herein depicts an article of a personal wearable computing device, particularly a head mount display (HMD) device that provides user a type of augmented reality (AR) experience by displaying relevant spatially-registered computer-generated (CG) contents that are superimposed with the user's surrounding environment with feature that the CG contents can be selectively concealed from the surrounding people and visible only to the user. Accordingly to an aspect of the invention, the invention enhances the user's current perception of reality by providing information that appears to be part of the real world while allowing the user to have an improved private access of such information.

The present embodiments relate generally to the HMD device, which is an optical see-through device comprises at least a front facing camera, a battery, a CG content engine coupled to an on-board computing system, an image source and an optical see-through display system for each of the user's eyes. The optical see-through display further comprises an optical combiner and at least a layer of liquid crystal display (LCD) panel placed at the outermost layer of the optical combiner. The optical combiner is a type of lens element that is partially transmissive and partially reflective, which allow the CG content projected from the image source be reflected to the user eyes while permitting the user to keep a sight of the real world such that the CG content is superimposed to the augmented object in the real world. Due to the partial transparency of the optical combiner, the CG content is exposed to the surrounding people. Thus, to conceal the CG content and make it accessible only to the user for an improved private access of information, a portion of the LCD panel would change its transparency from clear to opaque when a voltage is applied so as to create an occlusion mask pattern with position and dimensions correspond to the CG content displayed on the optical combiner. The position and dimension of the CG content and thus the occlusion mask pattern are further configured to change simultaneously according to several factors, including the position of the augmented object in the real world with respect to the position of the user's head. The occlusion mask pattern created on the LCD panel is limited thereby leaving the user an acceptable field of view of the real world.

In another embodiment, the device is capable of producing a composite scene by electronically combining a real-world image with a computer generated image containing the AR elements, wherein the composite scene is blocked off in view of the surrounding people and is displayed as if it is in the same location in the real world when the user views through the device.

In another embodiment, the LCD panel is replaced by a photochromic lens or other light adaptive means that is capable of changing the transparency from clear to opaque when exposed to specific types of light of sufficient intensity.

In another embodiment, the device contains software algorithms to identify the type of CG content, e.g. sensitive information, characters, objects, effect in the real world etc. such that an occlusion mask pattern suitable to the CG content is created.

In another embodiment, the occlusion mask pattern can be switched on and off by the user regardless of the type of CG content being displayed on the optical combiner.

### BRIEF DESCRIPTION OF THE DRAWINGS

The various preferred embodiments of the present invention described herein can be better understood by those skilled in the art when the following detailed description is read with reference to the accompanying drawings. The components in the figures are not necessarily drawn to scale and any reference numeral identifying an element in one drawing will represent the same element throughout the drawings. The figures of the drawing are briefly described as follows:

FIG. 1 is a perspective view of a binocular optical see-through head mount display (HMD) device using two optical see-through display systems, in accordance with an embodiment of the disclosure.

FIG. 2 is a top view of a binocular HMD device, according to an embodiment of the present invention.

FIG. 3 is a perspective view of an optical see-through HMD device with a layer of liquid crystal display panel or means alike, according to an embodiment of the present invention.

### DETAILED DESCRIPTION OF THE INVENTION

The present invention described herein depicts a wearable personal computing device that is capable of enriching a user's view of the real world by augmented reality (AR). More specifically, the invention provides an improved privacy feature to the user, in which AR as represented by computer-generated (CG) content is visible to the user only but concealed from the surrounding people when it is presented on an optical see-through head mount display (HMD).

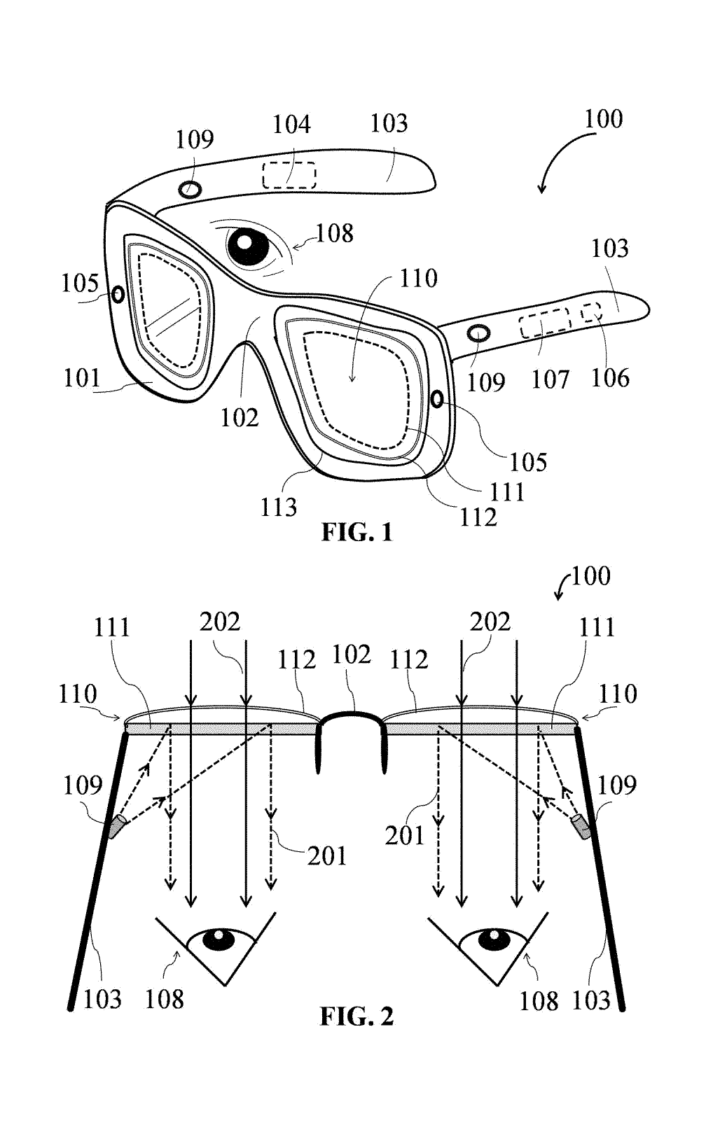

FIG. 1 is a perspective view of an optical see-through HMD device 100 for use in AR, which is in accordance with an embodiment of the present invention. In this embodiment, the device 100 has a frame front 101, a nose bridge support 102 and two extending side arms as the temples 103, which are designed to be secured on a user's face via the nose and the ears. The device 100 may be in a form of solid or hollow structure that acts as housing for the electronic components embedded within the device 100 and as conduit for the electrical connections. While an eyeglass is illustrated in FIG. 1, other alternative forms of a head-worn computing device are conceivable (e.g. a visor with temples and nose bridge support, a headband, goggles type eyewear, etc.) Further, the device 100 may be implemented as a monocular HMD as well as the binocular embodiment as illustrated.

The illustrated embodiment of the device 100 further comprises a battery 104 mounted on the temple 103 for providing power to the electronic components of the device 100, and at least a front facing camera 105 mounted on the frame front 101 for recording digital images and videos of the real world. The data is then relayed to a computer-generated (CG) content engine 106 that is communicatively coupled to an on-board computing system 107 to generate relevant and spatially-registered CG content in real time so as to augment or supplement the real-world environment. The CG content engine 106 and the on-board computing system 107 may be disposed in or on the temples 103. The CG content engine 106 may include a graphic processor for rendering images data while the on-board computing system 107 may include a processor, memory and software algorithms for controlling the electronic components of the device 100.

The CG content is displayed or projected by an image source 109, which may be mounted in the user's peripheral vision such as the inner side of the temple 103 or on other positions of the frame front 101 that does not obstruct the forward vision of the user. The CG content may be displayed virtually in a form of characters, objects or effects in the real world etc. In one embodiment, the image source 109 is a monitor or a micro-projector that may be implemented in various compact image source technologies such as organic light emitting diode (OLED), liquid crystal on silicon (LCoS) and ferroelectric liquid crystal on silicon (F-LCoS) technologies.

In accordance with the disclosure, an optical see-through display system 110 that is capable of superimposing the CG content over the real world is mounted to the frame front 101 for each of the user's eyes 108. The optical see-through display system 110 comprises an optical combiner 111 and at least a layer of photochromic lens, or liquid crystal that preferably in the form of a transparent liquid crystal display (LCD) panel 112, or other light adaptive means that is capable of changing its transparency. Depending on the location of the image source 109, the optical see-through display system 110 may further comprises lens elements and/or mirrors to steer the CG content light towards the optical combiner 111.

Referring now to FIG. 2, the optical combiner 111 in the optical see-through display system 110 operates in both reflection and transmission modes simultaneously with each mode having different characteristics. The optical combiner 111 is designed to be partially reflective and partially transmissive such that the user can see the real world and the virtual CG content at the same time. In transmission mode, the light from the real world 202 is passed to the user's eye 108 so that the user can look directly through it to see the real world. In reflection mode, a portion of the CG content light 201 output from the image source 109 is reflected back towards the user's eye 108. Therefore, the optical combiner 111 combines the light from the real world 202 with the CG content light 201 such that in the user perspective, the real world is supplemented with virtual objects that appear to coexist in the same space as the real world. In one embodiment, the optical combiner 111 may be mounted in front of the user's forward vision of each of the user's eyes 108 by an eye wire 113. It may be made of a variety of clear optical materials in various forms such as prisms, beam splitter, partially reflective mirror, surface distributed micro-mirrors, waveguides, diffraction gratings and light field.

Unlike video see-through HMD, which is another type of HMD used for AR that electronically combines the CG content with a captured image of the real world and subsequently projects the composited scene to an opaque element, optical see-through HMD requires using transparent optics in the line of sight of the user without obstructing the user's forward vision such that the CG content can be directly superimposed over a real-world view. Due to the transparent nature of the optics in front of the user's eye 108, any CG content that falls on the see-through display system 110 is visible to both the user and the surrounding people.

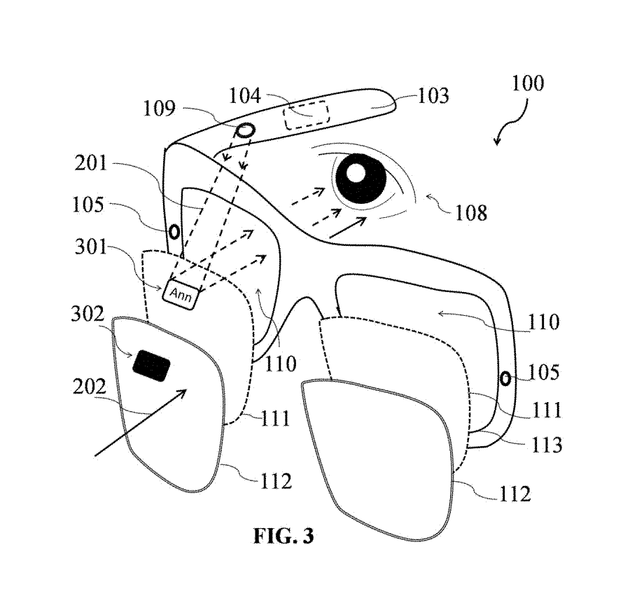

FIG. 3 illustrates an exemplary embodiment of the optical see-though display system 110 that is capable of providing the user an improved private access of information, i.e. the CG content 301 displayed on the optical combiner 111 is visible to the user only but concealed from the surrounding people. As illustrated, the transparent LCD panel 112 is placed at the outermost layer of the optical combiner 111 (i.e. farthest away from the user's eyes 108). The phase and alignment of the liquid crystal change when a voltage is applied to the LCD panel 112, wherein certain segments of the liquid crystal as a form of dots or pixels are turned on and off individually, thereby certain parts of the LCD panel 112 become either opaque or transparent.

In accordance with the present invention, the LCD panel 112 is clear when the pixels are turned off that allows light passing through, while it becomes blackened when the pixels are turned on to create a kind of mask that blocks off any light. By applying voltage to the LCD panel 112 that selectively turns on certain pixels, an occlusion mask pattern 302 is created on the LCD panel 112. As controlled by the same on-board computing system 107, the position and dimension of the CG content 301 being displayed on the optical combiner 111 are used to synchronously turning on and off the corresponding pixels on the LCD panel 112 such that only a selected area of the LCD panel 112 is occluded. It is, therefore, the CG content 301 is blocked off in the view of the surrounding people. In the user perspective, the overall field of view of the real world is not obstructed except the area with the occlusion mask pattern 302, on which the CG content 301 is displayed to the user. Since the CG content 301 occupies only a limited portion of the optical combiner 111, the corresponding occlusion mask pattern 302 created on the LCD panel 112 is limited as well thereby leaving the user an acceptable field of view of the real world.

In one exemplary, software algorithms such as facial recognition software may be embedded in the on-board computing system 107 such that the device 100 is capable of identifying the name of a person based on a face image captured by the front facing camera 105. A series of virtual characters representing the name of that person (e.g. 301), which is generated by the CG content engine 106, is presented to the user through the image source 109 and the optical see-through display system 110. Therefore, a name would appear next to a person's head, for instance, when the user looks at that person through the device 100.

It is noted that the position and dimension of the CG content 301 as displayed on the optical combiner 111 vary according to several factors, such as the gaze of the user, the depth of focus of the user, the amount of the CG content 301 being presented and the actual spatial location of the augmented object in the real world, etc. Therefore, the dimension and position of the occluded area on the LCD panel 112 (i.e. the occlusion mask pattern 302) change accordingly. As the CG content 301 represents the augmentation elements of an object in the real world, in an exemplary implementation, the CG content 301 displayed on the optical combiner 111 will move along with the object whenever the position of the object in the user's field of view changes in respect to the user's head. Subsequently, the position of the occlusion mask pattern 302 created on the LCD panel 112 is adjusted synchronously.

In the principle embodiment, the on-board computing system 107 further comprises software algorithm to identify the type of the CG content 301 being generated, i.e. CG content 301 that contains characters, objects, effect in the real world or a combination thereof. As a default setting of the software, a rectangular occlusion mask pattern 302, as an example depicted in FIG. 3, is created on the LCD panel 112 to entirely conceal the CG content 301 from view of the surrounding people when the CG content 301 contains merely characters.

Alternatively, when the CG content 301 contains superimposed objects and/or effects in the real world that requires simultaneously viewing the CG content 301 and the augmented object(s) in the real world, the device 100 will not generate an occlusion mask pattern 302 on the LCD panel 112 by default, wherein the LCD panel 112 remains transparent so as not to block the light from the real world 202. For example, if the CG content 301 contains Global Positioning System (GPS) data such as path directions, street names and points of interest, the user will need to have a direct view of the surrounding environment in real time, wherein the view is overlaid with the GPS data by displaying the CG content 301 on the optical combiner 111.

In yet another embodiment, the on-board computing system 107 further identifies sensitive information in the CG content 301, e.g. identifying personal information among other CG objects. In this implementation, an occlusion mask pattern 302 is created on the LCD panel 112 that selectively conceals a partial portion of the CG content 301, particularly only the sensitive information is blocked off in the view of the surrounding people but leaving the remaining CG objects exposed such that the user has a maximum field of view of the real world while having a private access of certain information.

In all the previous embodiments, the occlusion mask pattern 302 can be switched on and off by the user through changing the default setting of the on-board computing system 107. Based on the user preference, the device 100 may be configured to create an occlusion mask pattern 302 that entirely blocked off the CG content 301 in the view of the surrounding people, or an occlusion mask pattern 302 that blocks off only a portion of the CG content 301 but leaving the remaining CG content 301 exposed to the surrounding people. Likewise, user can configure the device 100 to not create any occlusion mask pattern 302 regardless of the type of CG content being displayed on the optical combiner 111, such that the LCD panel 112 remains transparent at all time and thereby, the user's overall field of view of the real world is not obstructed.

In a further embodiment, the on-board computing system 107 further comprises software algorithm and/or image processor that is capable of rendering a composited scene for a situation that the user prefers to block off the CG content 301 but a view of the augmented object in the real world is necessary to provide the user an AR experience. For example, virtually changing the color or adding visual effect to an object in the real world would require viewing the CG content 301 and the augmented object at the same time. For this type of AR experience, the CG content 301 is displayed as if it overlaps or is in close proximity to the augmented object in the real world. Accordingly, the corresponding occlusion mask pattern 302 as created based on the user preference will block the user from directly viewing the augmented object in the real world, as the augmented object in the real world, the CG content 301 and the occlusion mask pattern 302 are in the same line of sight when the user views through the device 100. Therefore, a composited scene is constructed by overlaying the CG content 301 onto a real-time image of the augmented object that may be captured by the front facing camera 105, whereby the composite scene is projected to the optical combiner 111 that is reflected back to the user's eyes 108, but the composite scene is blocked off in the view of the surrounding people by the occlusion mask pattern 302 created on the LCD panel 112. To further illustrate this embodiment, for example, consider the augmented object is a Christmas tree in the real world and the desired augmentation element is an addition of a plurality of lights globes on that Christmas tree but the CG content 301 have to be concealed from the view of the surrounding people accordingly to the user preference. Thus, an occlusion mask pattern 302 is created to conceal the CG content 301 but also it blocks the user's direct sight of the Christmas tree in the real world. To overcome this issue, an image of the Christmas tree in the real world is captured by the front facing camera 105 and electronically combined with a computer generated image of the lights globes to produce a composited scene of a lighted Christmas tree that is visible to the user only. The composited scene is then displayed to the user as if it is in the same location in the real world when the user views through the device 100.

In yet another embodiment, the LCD panel 112 is replaced by photochromic lens or other light adaptive means that is capable of changing its transparency from clear to opaque on exposure to specific types of light of sufficient intensity. When the light intensity falls below an activation threshold, the photochromic lens or other means alike would remain clear, which light from the real world 202 would pass to the user's eye 108. Therefore, only the portion that is shined by the CG content light 201 with sufficient intensity will be darken and thus creating an occlusion mask pattern 302 correspondingly to the dimension and position of the CG content 301 displayed on the optical combiner 111. By varying the intensity of the CG content light 201, one can selectively conceal the CG content 301 entirely or partially from the view of the surrounding people. Similarly, the occlusion mask pattern 302 can be switched off based on the user preference by adjusting the intensity of the CG content light 201 to a level below the activation threshold.

In a further embodiment, the device 100 may include a series of inertial sensors such as gyroscope, accelerometer and magnetometer for sensing position, orientation, and movement of the user. Microphone, speaker and wireless connectivity may be implemented into the device 100 as well.

The invention claimed is:

1. An optical see-through head mount display (HMD) device for displaying a computer-generated (CG) content to a user to provide a type of augmented reality (AR) with private access of information, wherein the HMD comprises of:
an optical see-through display system for each of an user's eyes comprising:
an optical combiner that is partially reflective and partially transmissive; and
an optical means that changes from transparent to opaque for creating an occlusion mask pattern;
a computer-generated (CG) content engine;
an on-board computing system coupled to the said CG content engine to generate spatially-registered CG content; and
an image source for each of an user's eyes to display the said CG content to the said optical combiner.

2. The optical see-through HMD device as in claim 1, wherein the on-board computing system further comprises:
an algorithm to control the optical means in creating an occlusion mask pattern on the said optical means, in which the dimension and position of the said occlusion mask pattern corresponding to the dimension and position of the CG content being displayed on the optical combiner.

3. The optical see-through HMD device as in claim 1, wherein the on-board computing system further comprises:
an algorithm to identify the type of CG content being displayed on the optical combiner such that an occlusion mask pattern is created on the optical means that blocks off the said CG content completely or partially from view of surrounding people.

4. The optical see-through HMD device as in claim 1, wherein the on-board computing system further comprises:
an algorithm to identify the type of CG content being displayed on the optical combiner such that an occlusion mask pattern is not created and the optical means remain transparent.

5. The on-board computing system as in claim 1, wherein the occlusion mask pattern created on the optical means can be switched on and off based on user preference.

6. The optical see-through HMD device as in claim 1, wherein the on-board computing system further comprises:
an algorithm to create an occlusion mask pattern on the optical means based on a user preference; and
an image processor to render a composited scene by electronically combining an image of an augmented object in the real world and a spatially-registered CG content.
